(19) United States
(12) Patent Application Publication
(10) Pub. No.: US 2022/0129283 A1
(43) Pub. Date: Apr. 28, 2022

(54) METHODS, SYSTEMS, AND MEDIA FOR GENERATING AN UPDATED WORKFLOW FOR AN OPERATION EXECUTABLE BY A COMPUTING DEVICE

(71) Applicant: Capital One Services, LLC, McLean, VA (US)

(72) Inventors: Neeraj SHARMA, Glen Allen, VA (US); Jeffrey A. TYREE, Powhatan, VA (US); Siwatm PIYASIRISILP, Herndon, VA (US); Andrew Troy HARTWELL, Prosper, TX (US); Suresh VADIGI, Kennett Square, PA (US)

(73) Assignee: Capital One Services, LLC, McLean, VA (US)

(21) Appl. No.: 17/079,767

(22) Filed: Oct. 26, 2020

(51) Int. Cl. G06F 9/445; G06F 8/30; G06F 3/0486; G06F 3/0482

(52) U.S. Cl. CPC G06F 9/44505; G06F 3/0482; G06F 3/0486; G06F 8/31

(57) ABSTRACT

The present application is directed to methods, systems, and media, implemented in a non-production environment, for automatically generating an updated workflow for an operation executable by a computing device. A selection of an operation from among a plurality of operations available in a microservices environment is received via a user interface. A configurable computer-executable file corresponding to the selected operation is determined. An alteration to the operation is received via the user interface. A segment of computer-executable code in the configurable computer-executable file corresponding to the selected operation is updated responsive to the alteration to the operation. Updated workflows available to other applications in the microservices environment are generated based on the updated segment of computer-executable code in the configurable computer-executable file.

### BACKGROUND

When creating or updating features for web sites and applications, developers have a number of tools to make and implement changes at their disposal. In fact, the tools involved in this work are themselves constantly being improved. While the work to build these features can at times be difficult, creation is merely the first step in the process. Testing is also an integral component in these code-developing efforts, as is the ability to share and re-use previously developed features of a system.

Developers for financial services institutions like banks and other credit providers face additional challenges due to the complexity of the systems involved in delivering technology to their customers. For example, there can be multiple and varied requests to place, a number of data stores to access, and a several permissions to grant in order to complete just one function or series of functions in the system. Oftentimes regulations can make the testing environment itself difficult, further increasing that level of complexity.

When operating in a “microservices” environment to deliver these features, all services are loosely coupled and have extremely segmented functionality. While this has advantages, as each microservice can run independently of each other microservice, it also presents drawbacks. The narrow functionality means that several microservices may be used for previously singular actions, potentially twenty or more in some instances. With that as the development backdrop, the level of detail and intricacy is increased by yet another factor.

Accordingly, a system to simplify development processes and testing in a microservices environment is needed.

### BRIEF DESCRIPTION OF THE DRAWINGS

Descriptions are given with reference to the figures included herein. When possible and for clarity, reference numbers are kept consistent from figure to figure. Some of the figures are simplified diagrams, which are not to be interpreted as drawn to scale or spatially limiting for the described embodiments. Where appropriate, the particular perspective or orientation of a figure will be given to increase understanding of the depicted features.

FIG. 1 is a high-level block diagram of a system for generating an updated workflow, according to an embodiment of the application;

FIG. 2 is a more detailed illustration of a system for generating an updated workflow, according to an embodiment of the application;

FIG. 3 is a flowchart representing a method for automatically generating an updated workflow, according to an embodiment of the application;

FIG. 4 is an example of a user interface, according to an embodiment of the disclosure; and

FIG. 5 is a computer system useful for implementing various embodiments.

### DETAILED DESCRIPTION

Development systems would be improved if developers were able to automatically update and share operations that are used in a non-production environment. The process would be further enhanced if interfaces, methods and systems were available to abstract those features, reducing the developer's background used to share and repeat certain development tasks. Embodiments of the present disclosure are directed to methods, media, and systems of generating a workflow for updating an operation executable by a computing device in a microservices environment.

A user interface can be used to create functionality, such as changing a contact method, changing a delivery method, making information visible via a user interface that was previously not made visible, preventing display of information via a user interface that was previously made visible, renaming a variable, or specifying a field of information for manipulation among a plurality of fields of information. Once created, this functionality is re-usable according to embodiments of the present application—that is once published, every other developer in the system has access to and can utilize that same functionality.

The components and/or architectural elements described above and below can be employed in an overall software development system to aid developers across a range of activities. These and other embodiments can be particularly useful for a financial institution such as a bank, credit union, or credit card provider. As a single source of developer tools, various applications can be used within the environment to overcome challenges specific to the industry.

The combination of regulatory and technical complications associated with the security of information for financial institutions creates a unique set of challenges that this system addresses. Primary among those impediments are the complexity of the constituent pieces involved, the interconnected nature of the sub-systems and processes, and the specificity of each. To meet and overcome those hurdles, the disclosed system reduces the burden placed on a developer with respect to required background knowledge. The described sub-systems, elements and tools also work together (with the aid of “METHODS, SYSTEMS, AND MEDIA FOR A MICROSERVICES ORCHESTRATION ENGINE”, U.S. patent Appl. Ser. No. ______ (Atty. Dkt. No. 4375.1300000), incorporated by reference herein in its entirety) to provide interconnected solutions across the development life cycle.

Starting with the business processes that underly each of the phases that a developer must address, the overall development architecture disclosed in this application can be used to guide a software innovation in the financial services field from start to finish. Once business processes are identified (with or without the use of the specific tools described in the present disclosure), the software development environment can be used to create test users and accounts (which is discussed in further detail in “GENERATING TEST ACCOUNTS IN A CODE-TESTING ENVIRONMENT”, U.S. patent Appl. Ser. No. ______ (Atty. Dkt. No. 4375.1290000), incorporated by reference herein in its entirety). A developer can further test users and accounts through each phase of a variety of transactions expected of those users/accounts, and even test processes with outside vendors and third parties which previously had no means for testing (found in “METHODS, SYSTEMS, AND MEDIA FOR GENERATING TEST AUTHORIZATION FOR FINANCIAL TRANSACTIONS”, U.S. patent Appl. Ser. No. ______ (Atty. Dkt. No. 4375.1520000), incorporated by reference herein in its entirety and “METHODS, SYSTEMS, AND MEDIA FOR ACCESSING DATA FROM A SETTLEMENT FILE”, U.S. patent Appl. Ser. No. ______ (Atty. Dkt. No. 4375.1530000), incorporated by reference herein in its entirety).

The phase-by-phase analysis of code under development can also be used to test recurring transactions, interconnected transactions (e.g., authorization and settlement), or produce negative testing/edge testing scenarios of a completely hypothetical nature. The ability to connect the various processes can allow a developer to probe the interactions that occur due to changes in existing products and services, as well as explore the performance of code for new products and services. The architecture and implementation of the disclosed systems have been created in such a way as to also provide “cascading” updates. The level of abstraction within the disclosed framework ensures that changes made at one point in the system are reflecting in related processes elsewhere in the development architecture (e.g., alterations made in generated business workflows should affect other testing tools are updated in those other applications).

To generate a workflow, an operation such as one of those given above or below is selected. A segment of computer-executable code of a configurable computer-executable file corresponding to the selected operation is altered. Responsive to execution of the alterations in the segment(s) of computer-executable code being executed by one or more processors/computing devices, the computer-executable file is updated to according to the alterations. A workflow for updating the selected operation is generated responsive to the configurable-executable code being updated, which is then available to other applications in the microservices environment.

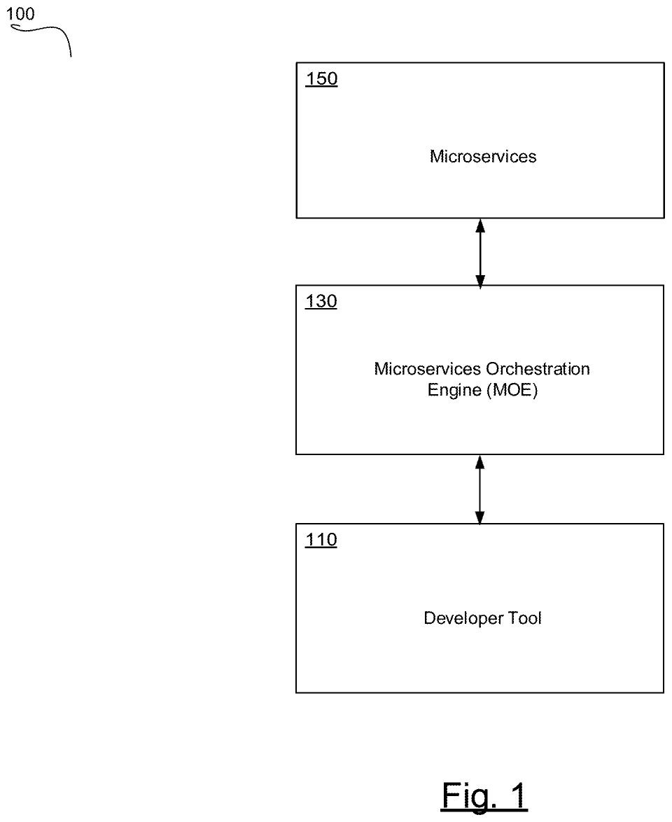

FIG. 1 is a high-level block diagram of a system 100 for automatically generating an updated workflow for an operation, the workflow executable by a computing device, in accordance with embodiments of the present disclosure. Included in the system 100 are developer tool 110, microservices orchestration engine (MOE) 130, and data stores 150. In some examples, data stores 150 may include microservices and/or any data associated therewith. Developer tool 110 is shown communicating with MOE 130, and MOE 130 is shown communicating with data stores 150.

Included in developer tool 110 is a business workflow generator, having a user interface, for creating a workflow to update an operation which is executable by a computing device. The operation may be updated through altering segments of computer-executable code included in a configurable computer-executable file corresponding to the operation. The configurable computer-executable file is programmed in a programming language that is at least partially human-readable. For example, the configurable computer-executable file can be a Java Script Object Notation (JSON) file.

The operation is updated responsive to the alterations in the segments of computer-executable code included in the configurable computer-executable file corresponding to the selected operation being executed by a computing device and/or processor. The updated operation can include changing a contact method, changing a delivery method, making information visible via a user interface that was previously not made visible, preventing display of information via a user interface that was previously made visible, renaming a variable, or specifying a field of information for manipulation among a plurality of fields of information. As an example, specifying a field of information may include updating a phone number or a mailing address corresponding to a user account.

In embodiments consistent with the present disclosure, a developer using developer tool 110 may alter segments of computer-executable code with information contained in data stores 150. In some examples, permission to access the contents of data stores 150 is requested. Transmission of information used to alter the segments of computer-executable and requests for permissions to access the data stores 150 storing the information being transmitted may be coordinated via MOE 130. Responsive to the permissions being granted, the contents of data stores 150 corresponding to the segments of computer-executable code of the configurable computer-executable file being altered by the developer (e.g., the JSON file) is transmitted to a business workflow generator included in developer tool 110 to generate the workflow. The generated workflow may be used to perform subsequent updates to the operation.

In embodiments, the workflow may be generated in a non-production environment. Examples of a non-production environment may include a code-testing environment and/or a quality assurance (QA) environment. Once generated, the workflow may be integrated into other development scenarios, such as those used for generating test accounts, testing authorization processes, or formatting settlement files.

Data stores 150 may belong to or otherwise be affiliated with an institution implementing developer tool 110, or data stores 150 may belong to or otherwise be affiliated with third-parties external to the institution. Examples of third parties to whom data stores 150 may belong and/or otherwise be affiliated with include credit bureaus/reporting agencies, credit processing entities, medical facilities, and educational institutions. Permission to access the data stores 150 may be requested and/or granted without regard to the level of administrative privilege of the requestor/grantor.

Various communications protocols enable communications between development tool 110, MOE 130, and data stores 150. The same or different protocols can enable requests between development tool 110 and MOE 130 as those that also enable the access requests between MOE 130 and data stores 150. The protocols can include, but are not limited to, calls to databases, mainframes, and application programming interfaces (APIs), as well as calls between cloud services and cloud files, schedulers and scheduler calls, and/or other suitable means of communicating between the various components. Furthermore, the alterations to operations can involve a combination of Simple Object Access Protocol (SOAP) service calls, Oracle and/or SQL database calls, calls to miscellaneous databases, database (DB) gateway calls, Representational state transfer (RESTful) application programming interface (API) calls, T-SYS mainframe emulator communications, third-party data source communications, cloud services files, and/or scheduler calls.

As an example, a developer using developer tool 110 can update a feature displaying a piece of information after a change of address for a user profile. The developer can use developer tool 110, in conjunction with MOE 130 and data stores 150, to pull the microservice calls for an account number and the address field. Rather than show any accessed or changed information, the developer can alter the notification to the date and/or timestamp of the change. Developer tool 110 will then communicate with MOE 130 and data stores 150 again to publish this change, thus making it available of other users of system 100. Through the entire process, developer awareness can be reduced to the desired actions or functions, without delving into the specifics of the requests, permissions, formatting or the like. This can extend to other development applications, such as those used to generate test users and accounts, in order to update the profiles of the generated test accounts.

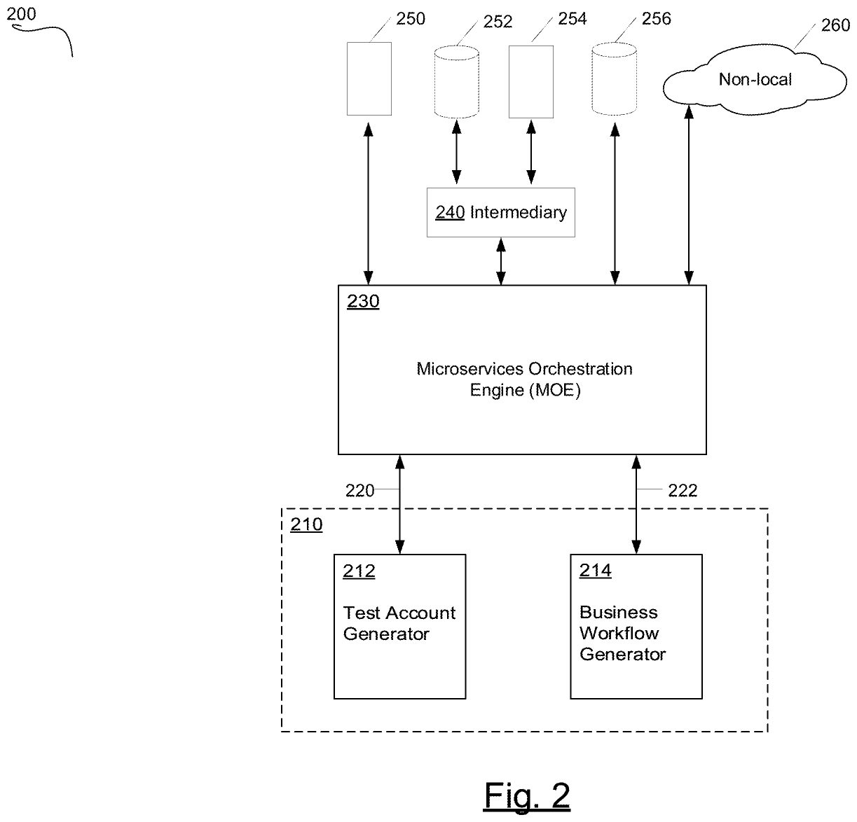

FIG. 2 illustrates a system 200 for automatically generating an updated workflow for an operation. System 200 is consistent with the system depicted in FIG. 1, and provides additional details of certain components in accordance in accordance with embodiments of the present disclosure. Included in system 200 is developer tool 210, microservices orchestration engine (MOE) 230, intermediary 240, microservices 250, 252, 254, and 256 (collectively ‘the microservices 25X’), and non-local data stores 260.

As shown in FIG. 2, developer tool 210 can include test account generator 212 and business workflow generator 214. MOE 230 can be configured to communicate with test account generator 212 and business workflow generator 214, through two-way communications 220 and 222, respectively. Developer tool 210 and business workflow generator 214 can interact with MOE 230 through protocols, means or components that are either consistent or entirely different.

In embodiments, a selection of an operation from among a plurality of operations available in a microservices environment is made via a user interface of business workflow generator 214. Business workflow generator 214 can receive the selection through any of several input/output operations, such as a drag-and-drop operation, a click, a cursor selection, a button selection, a keyboard input or the like. Input/output devices through which an operation may be selected include a monitor or other display device, a touchscreen or other touch-sensitive device, a mouse, a keyboard, a trackpad, a signature pad, or a combination thereof. The selection is then communicated with MOE 230 via communications 222.

Responsive to receiving the selection of an operation from business workflow generator 214 by way of MOE 230, a configurable computer-executable file corresponding to the selected operation is determined from among those stored at the microservices 25X′ and/or data stores 260. For example, the configurable computer-executable file can be a Java Script Object Notation (JSON) file, a Google Protocol Buffer (Protobuf) file, or an extensible markup language (XML) file. Receiving a selection of an operation may further include receiving an initial field of information used in performing the operation. Furthermore, the segment of computer-executable code corresponding to the selected operation may be one or more of a Simple Object Access Protocol (SOAP) service call, an Oracle database call, a SQL database call, a miscellaneous database call, a database (DB) gateway call, a Representational state transfer (RESTful) application programming interface (API) call, a T-SYS mainframe emulator communication, a third-party data source communication, communications with a cloud services file, and/or a scheduler call

An alteration to the selected operation is received, via the user interface of business workflow generator 214, and a segment of computer-executable code in the computer-executable file corresponding to the operation is updated responsive to the alteration. In some embodiments, updating the segment of computer-executable code responsive to the alteration to the operation may involve generating a segment of computer-executable code without receiving additional user-authored code. For example, business workflow generator 214 may generate the segment of computer-executable code through any of several input/output operations, such as the drag-and-drop operation, click, cursor selection or the like. One or more updated workflows are then generated by business workflow generator 214 based on the updated segment of computer-executable code in the configurable computer-executable file.

Operations that may be altered include one or more of changing a contact method and/or preference, changing a delivery method and/or preference, making information visible via a user interface that was previously not made visible, preventing the display of information (e.g., via a user interface) that was previously made visible, renaming a variable, or specifying a field of information for manipulation among a plurality of fields of information. Examples of variables that may be renamed and/or fields of information which can be manipulated may include a username, a password, a home address, an email address, a phone number, payment information, and/or a preferred payment method.

Information able to be made visible/hidden may include a passphrase, an account number, a social security number, and/or any other piece of personally identifiable information (PII) associated with the account. Additional examples of PII may include: a passport number, a tax identification number, a driver's license number, a student identification number, a patient number, bank account information, a mailing address, and/or an email address. An initial field of information may correspond to existing customer information held by an institution, information regarding a new customer of the institution, new information regarding an existing customer of the institution, or information imported from an external source. In the event the information is privacy protected (e.g., personally identifiable information), handling occurs responsive to the grant of permissions to access the information.

According to embodiments of the present disclosure, the altered segment of computer-executable code may be published to a centralized code repository (e.g., a database or other storage server) for subsequent access and utilization by additional applications operating in the system 200. In some examples, the additional applications may include microservice applications such as the ones stored in microservices 25X or data stores 260. In some embodiments, a developer at a financial institution may use system 200 to generate and/or update workflows, via a user interface, in a non-production (e.g., a code-testing) environment.

As an example, a developer using the user interface of business workflow generator 214 may wish to change the process by which a user's password can be changed. Rather than ask for only the old password, the developer may also wish to ask for a previously determined security question that has a drop-down menu included for the user's selection. Through business workflow generator 214, the developer can select a checking account profile field corresponding to the password, the security question prompt and drop-down menu fields, as well as fields for receiving the new password and verifying the new password.

Passing all of the involved parts of the change to MOE 230 by way of communications 222, the various microservices 25X and data stores 260 can be queried. At least one segment of computer-executable code that enables all of the various calls and values can be accessed, also from microservices 25X and/or data stores 260. Once the segment of code has been updated to include the new operation, including the security question prompt and drop-down menu entry, it can be stored where appropriate, again by way of MOE 230. Subsequent use of business workflow generator 214 and MOE 230 will then allow other developers access to the updated segment of code.

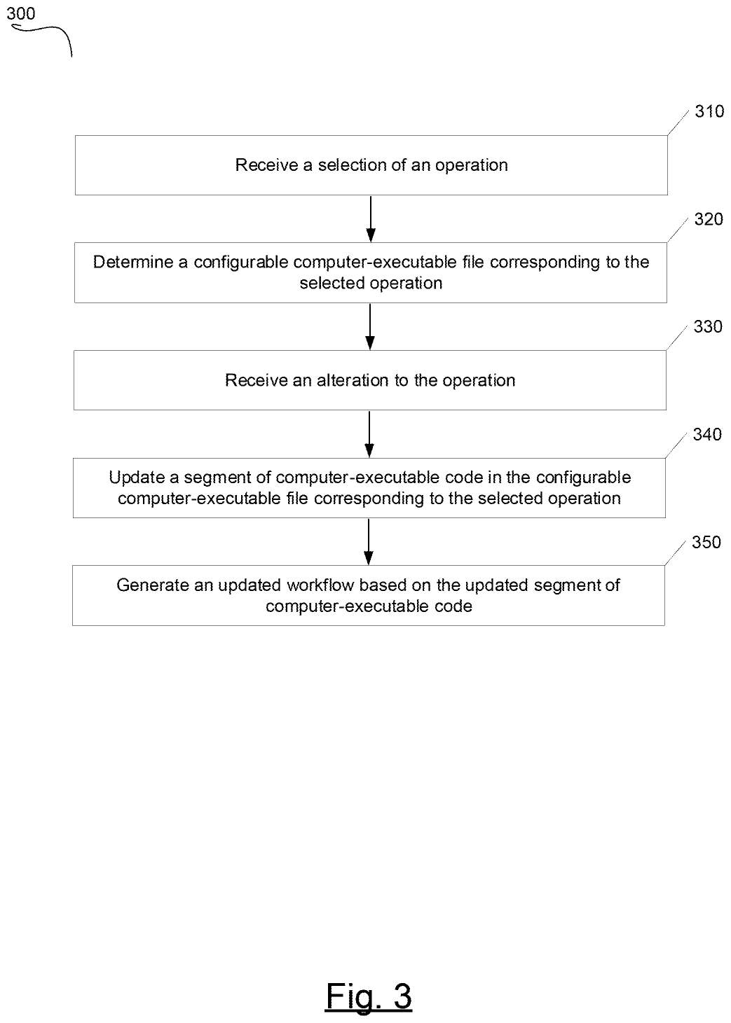

FIG. 3 depicts a method 300 of automatically generating an updated workflow in a non-production environment for testing computer-executable code, according to embodiments of the present application. Examples of a non-production environment for testing computer-executable code may include a code-testing environment, a quality assurance (QA) environment, or a combination thereof. The non-production environment can be used to test and develop features delivered through a microservices architecture.

Via a user interface, a selection of an operation from among a plurality of operations available in a microservices environment is received at a step 310. Examples of operations that may be selected are given above and below, such as changing a contact method/preference, changing a delivery method/preference, changing information visibility, or renaming a variable. A user interface may select the operation through one or more action, e.g., a drag-and-drop operation, a click, a cursor selection or the like. The selection can be entered through a variety of input/output devices such as a monitor or other display device, a touchscreen or other touch-sensitive device, a mouse, a keyboard, a trackpad, a signature pad, or various combinations thereof.

At a step 320, responsive to receiving the selection, a configurable computer-executable file corresponding to the selected operation is determined. For example, the configurable computer-executable file can be a Java Script Object Notation (JSON) file, a Google Protocol Buffer (Protobuf) file, or an extensible markup language (XML) file. The configurable computer-executable file corresponding to the selected operation can be stored in one of a number of data stores, e.g., in a central code repository.

At a step 330, an alteration to the operation is received via the user interface. Responsive to the alteration, a segment of computer-executable code in the configurable computer-executable file corresponding to the selected operation is updated at a step 340. One or more updated workflows is then generated at a step 350 based on the updated segment of computer-executable code in the configurable computer-executable file. Updated workflows and/or segments of code generated this way may be published to a central code repository where they are accessible by additional microservice applications.

As an example in accordance with embodiments of the disclosure, a developer may determine a reason to rename a variable associated with the previous year's tax documents, from “current_tax_form” to “2019_tax_form” based on the passage of filing deadlines. Via a user interface, a selection of the renaming operation is selected by a button selection by a mouse, keyboard, or trackpad. Based on the selection, an appropriate Java Script Object Notation (JSON) file is identified in a data store (e.g., in a central code repository in data store 260).

An alteration to the operation is received via the user interface, where the previously the “current_tax_form” was renamed to “2018_tax_form” based on the previous year's rollover. Responsive to the alteration, a segment of computer-executable code in the JSON file corresponding to the selected operation is updated, so that the updated workflow is in turn generated. Thereafter, the updated workflow can be published to a central code repository from the new segments of code, where it is then accessible by additional microservice applications. If a changed variable is used in other development applications (for example those for generating transaction authorizations or in settlement processing), the availability of the change in the central code repository allows that change to “cascade” through to any appropriate call.

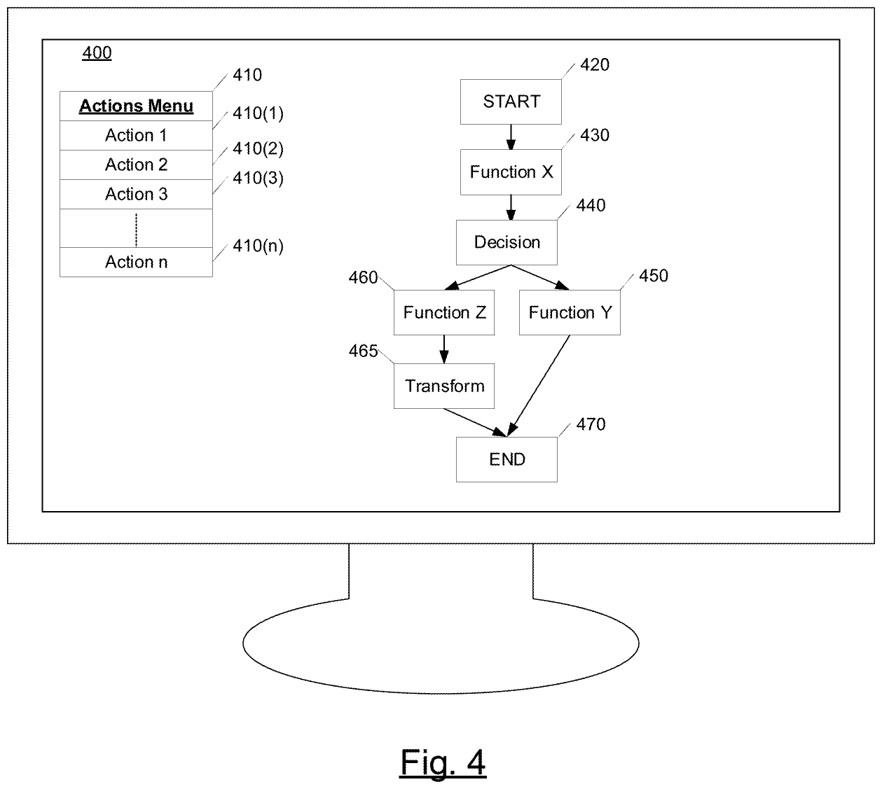

FIG. 4 depicts an example user interface 400 through which a developer at an institution may generate a business workflow using the developer tool(s) described above and below (e.g., the Developer Tool 110/210). Displayed via user interface 400 is Actions Menu 410. Actions Menu 410 includes Action 1 (410(1)), Action 2 (410(2)), Action 3 (410(3)), and Action n (410(n)) (collectively “Actions 410(x)”). Actions 410(x) may perform operations for: generating a new business workflow, adding a functional block (e.g., a function, a decision, and/or a transform) to a business workflow, editing the code underlying a functional block included in a business workflow, nesting a previously developed workflow into a more complex workflow, or terminating a business workflow, among other potential developer actions.

In embodiments, by using Actions 410(x) included in Actions Menu 410, a developer may instantiate functional blocks 420-470 to generate the business workflow represented on user interface 400. In accordance with the present disclosure, the functional blocks instantiated may be pre-existing functional blocks stored in a central repository (e.g., a server local to an institution with which the developer is associated). In some examples, functional blocks may be instantiated into a business workflow being generated via drag-and-drop operations, selection from a drop-down menu including other pre-existing functional blocks stored in the central repository, or selection made via a human interface device (e.g., any selection via a mouse, a keyboard, a trackpad, a signature pad, a touch-sensitive display device, and/or a combination thereof).

By selecting a functional block in a business workflow being generated, the developer may modify the code (e.g., the JSON, .xml, and/or Protobuf file, and all fields of information associated therewith) underlying the selected functional block if desired to ensure functionality of that particular block. Such modifications enable the business workflow being generated. Once generated, the business workflow may be saved to the central repository. Once saved to the central repository, a generated business workflow may be instantiated as its own functional block in business workflows generated in the future (i.e., nested in a more complex workflow).

A developer can begin a generated business workflow at the functional block representing start operation 420. Operations for starting a business workflow may include, but are not limited to, clicking on a link, making a selection from a drop-down menu, or making a selection via a human interface device. Other examples suitable for executing start operation 420 will be readily apparent to one of skill in the relevant art.

Responsive to start operation 420 of the business workflow, operation 430 can be added to execute a Function X. The function can be a function call to return a variable, perform an operation, input or output a value, or any combination thereof. Responsive to the execution of Function X at operation 430, a developer can add an operation 440, during which a decision is made.

Based on the decision operation 440, the developer can select operation 450 for Function Y or operation 460 for Function Z, which may be executed according to the workflow. In the example workflow shown, if it is decided at operation 440 that operation 450 calling Function Y is to be executed, responsive to completion of the same, the generated business workflow is to end at an endpoint 470. If, however, it is decided that operation 460 to call Function Z is to be executed, the results will undergo an operation 465 to perform a transformation before the generated business workflow ends at endpoint 470.

As a non-limiting example, a developer may want to generate a business workflow for ensuring the names of customers creating accounts associated with the institution of the developer, or the names of test accounts being generated by developers of the institution for the purposes of internal testing, are properly capitalized. Such a business workflow may be aptly named “Proper Capitalization”. A developer may be presented with a link to create an account associated with an institution. Responsive to clicking on the link, execution of “Proper Capitalization” begins at starting operation 420.

After filling in a portion of the information for creating the account, Function X operation 430 is executed. Operation 430 performing Function X may be a program tailored to ensure the first letter of the first name and the first letter of the last name provided by the user (or the developer if used in a testing scenario) is capitalized. Responsive to the execution of Function X at operation 430, a decision operation 440 is made as to whether the name has been properly capitalized.

If it is decided at operation 440 that the name associated with the account being created has been properly capitalized, Function Y executes at operation 450. Execution of Function Y at operation 450 may prompt the user/developer to continue the process of account creation. When the user/developer has finished creating the account, “Proper Capitalization” ends at endpoint 470.

If it is decided at 440 that the name associated with the account being created has not been properly capitalized, Function Z executes at operation 460. Execution of Function Z at operation 460 may still prompt the user/developer to continue the process of account creation in a manner substantially similar/identical to that presented when Function Y is executed at operation 450. However, in this scenario, the outcome of operation 460 is invocation of transform operation 465. Transform operation 465 may be, for instance, a script for automatically capitalizing the first letter of the string input into the field of information corresponding to “First Name” and the first letter of the string input into the field of information corresponding to “Last Name” during the account creation process. Responsive to the execution of Transform operation 465, “Proper Capitalization” ends at endpoint 470.

Throughout this example, the developer can accomplish all of the code development through simple manipulation in UI 400. For instance, the operations may already exist in a central repository, so that operations 430, 440, 450, 460, and 465 may be selected through a drop-down menu, a drag-and-drop operation, a list add/remove operation, or other suitable means of selection. Other straightforward actions may aid in the process, such as double-clicking on the operation to change underlying code, altering the connections or sequencing through the UI, or the like. Actions 410(x), among others, allow for starting, ending, and altering the workflow in UI 400 without resorting to complicated coding in a specific language, format or protocol. With UI 400, the workflows associated with individual operations/functions, such as operations 430, 440, 450, 460, and 465, can also be accessed, altered, and/or saved. The operations can be used throughout the non-production environment, for example with applications for enabling account generation, those testing transaction authorization, or tools for clearing settlements.

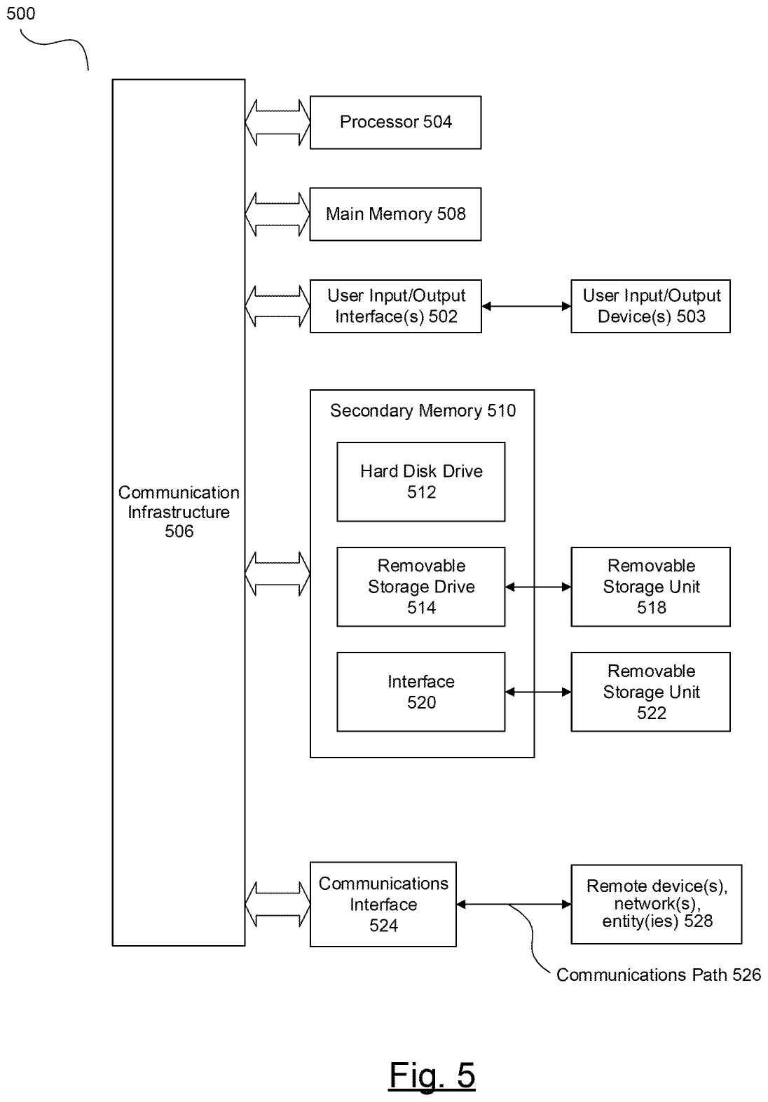

FIG. 5 depicts an example computer system useful for implementing various embodiments. Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 406 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data. Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not the Abstract section, is intended to be used to interpret the claims. The Abstract section may set forth one or more but not all exemplary embodiments of the present application as contemplated by the inventor(s), and thus, are not intended to limit the present application and the appended claims in any way.

The present application has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the application that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present application should not be limited by any of the above-described exemplary embodiments, but should be defined only in accordance with the following claims and their equivalents.

1. A method of automatically generating an updated workflow for an operation executable by a computing device, the method implemented in a non-production environment for testing computer-executable code, the method comprising:
receiving, via a user interface, a selection of an operation displayed by a screen of the user interface and available in a microservices environment;
determining, based on the selected operation, a configurable computer-executable file;
receiving, via the user interface, an alteration to the selected operation;
updating, based on the alteration to the selected operation, a segment of computer-executable code in the configurable computer-executable file; and
updating, based on the updated segment of the computer-executable code, one or more workflows, wherein the updated one or more workflows are available to a plurality of applications in the microservices environment.

2. The method of claim 1, wherein updating the segment of computer-executable code comprises generating an additional segment of computer-executable code without receiving additional user-authored code.

3. The method of claim 1, wherein receiving the selection of the operation further comprises receiving an initial field of information used in performing the operation.

4. The method of claim 1, wherein the alteration to the selected operation comprises one or more of: a change to a contact method, a change to a delivery method, a display of previously obscured information, obfuscation of previously displayed information, a change to a name of a variable, or a change to a field of information.

5. The method of claim 1, further comprising publishing the updated segment of the computer-executable code to a code repository for subsequent access by additional microservice applications.

6. The operation of claim 1, wherein the configurable computer-executable file is programmed in a programming language that is at least partially human-readable.

7. The method of claim 1, wherein the updated segment of the computer-executable code comprises one or more of: Simple Object Access protocol (SOAP) service calls, Oracle database calls, SQL database calls, Representational state transfer (RESTful) application programming interface (API) calls, T-SYS mainframe emulator communications, third-party data source communications, or scheduler calls.

8. A non-transitory computer-readable medium having instructions stored thereon that, when executed by at least one computing device, cause the at least one computing device to perform operations comprising:
receiving, via a user interface, a selection of an operation displayed by a screen of the user interface and available in a microservices environment;
determining, based on the selected operation, a configurable computer-executable file;
receiving, via the user interface, an alteration to the selected operation;
updating, based on the alteration to the selected operation, a segment of computer-executable code in the configurable computer-executable file; and
updating, based on the updated segment of the computer-executable code, one or more workflows, wherein the updated one or more workflows are available to a plurality of applications in the microservices environment.

9. The computer-readable storage device of claim 8, wherein updating the segment of computer-executable code comprises generating an additional segment of computer-executable code without receiving additional user-authored code.

10. The computer-readable storage device of claim 8, wherein receiving the selection of the operation further comprises receiving an initial field of information used in performing the operation.

11. The computer-readable storage device of claim 8, wherein the alteration to the selected operation comprises one or more of: a change to a contact method, a change to a delivery method, a display of previously obscured information, obfuscation of previously displayed information a change to a name of a variable, or a change to a field of information.

12. The computer-readable storage device of claim 8 further comprising publishing the updated segment of the computer-executable code to a code repository for subsequent access by additional microservice applications, wherein the configurable computer-executable file is programmed in a programming language that is at least partially human-readable.

13. The method of claim 8, wherein the updated segment of the computer-executable code comprises one or more of: Simple Object Access protocol (SOAP) service calls, Oracle database calls, SQL database calls, Representational state transfer (RESTful) application programming interface (API) calls, T-SYS mainframe emulator communications, third-party data source communications, or scheduler calls.

14. A system comprising:
a memory configured to store a set of computer-executable steps; and
one or more processors configured to perform the steps, the steps comprising:
receiving, via a user interface, a selection of an operation displayed by a screen of the user interface and available in a microservices environment;
determining, based on the selected operation, a configurable computer-executable file;
receiving, via the user interface, an alteration to the selected operation;
updating, based on the alteration to the selected operation, a segment of computer-executable code in the configurable computer-executable file; and
updating, based on the updated segment of the computer-executable code, one or more workflows, wherein the updated one or more workflows are available to a plurality of applications in the microservices environment.

15. The system of claim 14, wherein receiving the selection of the operation further comprises:
receiving an initial field of information used in performing the operation; and
updating the segment of computer-executable code comprises generating an additional segment of computer-executable code without receiving additional user-authored code.

16. The system of claim 15, wherein the generating the additional segment of the computer-executable code comprises altering the computer-executable code via the user interface.

17. The system of claim 16, wherein the altering the computer-executable code via the user interface comprises performing one or more of a drag-and-drop operation, a double-click operation, a right-click operation, a left-click operation, a drop-down menu selection, a list add/remove operation, a hover operation, a highlighting operation, or a button-selection operation.

18. The system of claim 14, wherein the alteration to the selected operation comprises one or more of: a change to a contact method, a change to a delivery method, a display of previously obscured information, obfuscation of previously displayed information, a change to a name of a variable, or a change to a field of information.

19. The system of claim 14, further comprising publishing the updated segment of the computer-executable code to a code repository for subsequent access by additional microservice applications, wherein the configurable computer-executable file is programmed in a programming language that is at least partially human-readable.

20. The system of claim 14, wherein the updated segment of the computer-executable code comprises one or more of: Simple Object Access protocol (SOAP) service calls, Oracle database calls, SQL database calls, Representational state transfer (RESTful) application programming interface (API) calls, T-SYS mainframe emulator communications, third-party data source communications, or scheduler calls.
